(19) United States
(12) Patent Application Publication
(10) Pub. No.: US 2014/0115577 A1
(43) Pub. Date: Apr. 24, 2014

(54) ESTIMATING DEMAND FOR NEWLY REGISTERED IMAGE TEMPLATES

(71) Applicant: INTERNATIONAL BUSINESS MACHINES CORPORATION, Armonk, NY (US)

(72) Inventors: Pradipta De, New Delhi (IN); Manish Gupta, New Delhi (IN); Amit S. Vaidya, Pune (IN)

(73) Assignee: International Business Machines Corporation, Armonk, NY (US)

(21) Appl. No.: 13/656,137

(22) Filed: Oct. 19, 2012

(51) Int. Cl. G06F 9/44

(52) U.S. Cl. 718/1

(57) ABSTRACT

Methods and arrangements for estimating demand for a newly registered virtual machine template. A newly registered virtual machine template is received, and prospective demand for the template is ascertained. Virtual machine instances are preprovisioned from the template.

### BACKGROUND

When a template is newly registered in a cloud context, which involves the use of virtual machines (VMs), it can be helpful to have some knowledge of the demand for the template. This can help in the preprovisioning of VM instances, and thus reduce the time required for delivery of provisioning requests.

However, since a newly registered template has no history, demand estimation becomes highly difficult. This is made even tougher by certain use cases of the cloud (such as “dev/test”, or development/test clouds) where a newly registered template is demanded by a set of users for a limited period of time and then the demand for it becomes zero.

### BRIEF SUMMARY

In summary, one aspect of the invention provides a method comprising: receiving a newly registered virtual machine template; ascertaining prospective demand for the template; and preprovisioning virtual machine instances from the template.

Another aspect of the invention provides an apparatus comprising: at least one processor; and a computer readable storage medium having computer readable program code embodied therewith and executable by the at least one processor, the computer readable program code comprising: computer readable program code configured to receive a newly registered virtual machine template; computer readable program code configured to ascertain prospective demand for the template; and computer readable program code configured to preprovision virtual machine instances from the template.

An additional aspect of the invention provides a computer program product comprising: a computer readable storage medium having computer readable program code embodied therewith, the computer readable program code comprising: computer readable program code configured to receive a newly registered virtual machine template; computer readable program code configured to ascertain prospective demand for the template; and computer readable program code configured to preprovision virtual machine instances from the template.

A further aspect of the invention provides a method comprising: receiving a newly registered virtual machine template; and ascertaining prospective demand for the template; said ascertaining comprising: identifying previously registered templates that are determined to be similar, via a quantitative closeness score computed between the newly registered template and the previously registered templates; and estimating demand on the basis of a weighted average of demand relative to the previously registered templates.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates relating a set of old templates to a new template.

FIG. 2 provides a schematic representation of template registration and of computation of base configurations to preprovision a new template.

FIG. 3 schematically illustrates a distribution of demand and weights of old templates with respect to a newly registered template.

FIG. 4 schematically illustrates a general process for estimating new template demand.

FIG. 5 sets forth a process more generally for estimating demand for a virtual machine template.

FIG. 6 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

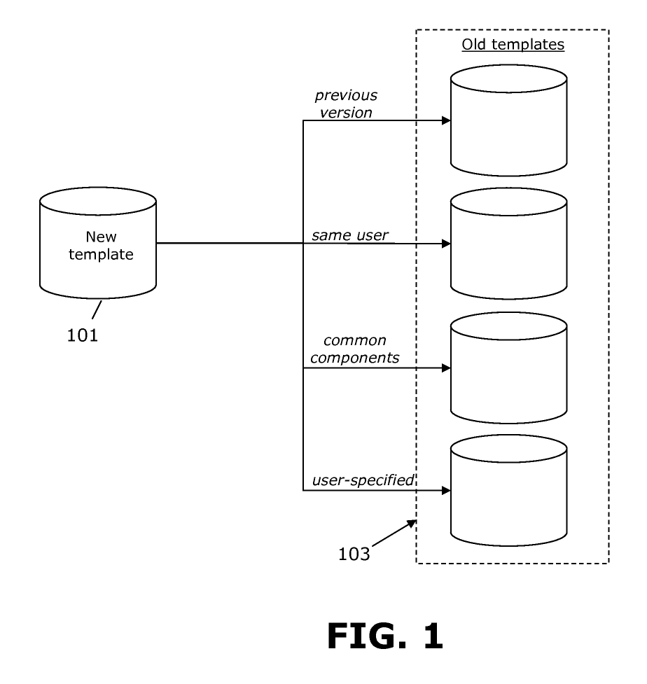

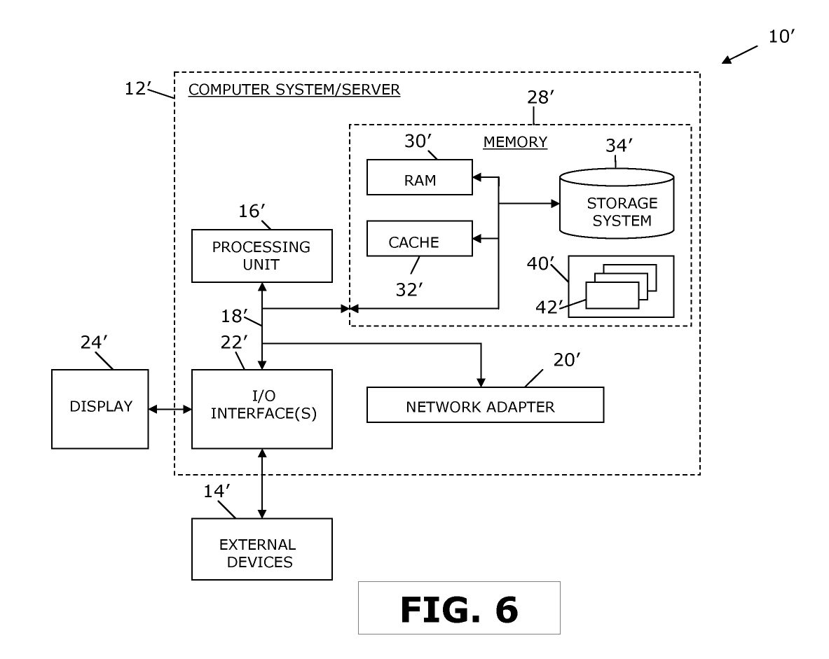

Specific reference will now be made herebelow to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 6. In accordance with an example embodiment, most if not all of the process steps, components and outputs discussed with respect to FIGS. 1-4 can be performed or utilized by way of a processing unit or units and system memory such as those indicated, respectively, at 16′ and 28′ in FIG. 6, whether on a server computer, a client computer, a node computer in a distributed network, or any combination thereof.

In accordance with at least one embodiment of the invention, in order to estimate demand for a newly registered template, features of the template are identified such as who created the template, any team with which the person registering the template is associated, whether the new template is a new version of a previous template, what software is contained in the template, and any of a great variety of other features. These features can then be used to identify a weight for each of the traces, where a trace refers to the sequence of requests that have been received for each of the different templates that are in the repository. Statistics of interest, such as demand, can then be calculated from these weighted traces.

In accordance with at least one embodiment of the invention, different scenarios are addressed depending on the degree and amount of demand-related information that can be inferred relative to a newly registered template. For instance, some templates may be associated with information such as “team” or “image version” that could exist, e.g., in cloud management software. On the other hand, some templates may not carry or be associated with such identifying information, and inferences may have to be made. Further, people from a team can raise multiple requests, while some members may not make any requests at all. This can be an important distinction in that when an individual has raised multiple requests, an implication arises that the new templates must be matched against all the templates that the user had created. In the event that a particular individual has not made any request, but belongs to the team that has used a template requested earlier, it may be important to infer the following: If there are N members in the team, and only M members requested templates (M<N), it still leaves the possibility that there can be N requests. In essence, although the user has never requested a template, it is still desirable to take team size into account while estimating the demand.

As such, in accordance with at least one embodiment of the invention, there are identified, for a given new template, all those past templates which are expected to determine the demand for the new template. To this end, the old and new templates are tagged with labels which assist in a computation or determination of “closeness” between the old and new templates. Such labels can include, but not be limited to: user ID's of team members expected to use a new template; software components contained in the respective templates; version numbers; and any of a great variety of other possible identifying factors.

In accordance with at least one embodiment of the invention, a distance of closeness, or closeness factor, is then computed between every pair of new and old templates. Demand, with respect to a prespecified time window, is estimated for each new template as a weighted average of the demand seen in the time window (of the same or similar length for the old templates). Then, configurations for preprovisioning the new template are computed.

As illustrated in FIG. 1, in accordance with at least one embodiment of the invention, different types of metadata can be used to identify related templates 103, which then can assist in providing an estimate of distribution for demand of a new template 101. Such metadata can include, but by no means be limited to: previous template versions; templates for which the user, who is registering the new template, is either the registering user or the user of the template; common software components between templates; and user-specified metadata.

In accordance with at least one embodiment of the invention, metadata associated with a newly registered template are analyzed to provide estimates for a team of users or individuals, on the basis of which demand distribution is subsequently estimated. Such metadata may include: specifications of user IDs of users who are expected to create an instance; all user IDs of users who are allowed or permitted to create an instance (wherein LDAP/TAM registries can be used for knowing the visibility of the new template); whether a user registering a template has registered earlier templates or has been a user of previously registered template (wherein a team is estimated by taking the union of the users of the previous templates for which either the person who registered a previous template is same as with the new template or was one of the users of a previous template); the version of a previous template (wherein a team is estimated by taking the union of the users who have created an instance from previous template versions); and a similarity relationship with other templates (as directly specified by the user or inferred from the components contained in the templates). “Visibility” here refers to the permission of a user to request a template. For example, within a team it may be that only the system administrator would be authorized to request new templates, and the privilege may not be assigned to developers. This information can be made available in the LDAP/TAM registries.

All such metadata can assist in directly or indirectly leading to an estimate of the team (e.g., via specification of user IDs) that will potentially create instances.

To compute pro-rata demand for a new template in a time window of interest, in accordance with at least one embodiment of the invention, let D be the estimate of the upper bound on demand for the newly registered template from the method discussed immediately above. D can be obtained simply by summing up the number of user IDs from the estimated “team”. For each of the related old templates t, determine the upper bound on demand Dₜ in the same way as was done for the new template. Pro-rata demand is then computed in the specified window w. For example, for template t, let the demand actually seen in the specified window w be D^{t}_{w}, whereupon the expected proportional demand for the new template will be D*D^{t}_{w}/Dₜ. Then, a weight xₜ is computed for each old template t, wherein this weight represents the closeness of the template's request pattern to the new template's expected request pattern. More particularly, the higher the value xₜ, the closer the two templates are. Finally, take the weighted average of statistics of interest (such as the mean demand in the window) across all the traces.

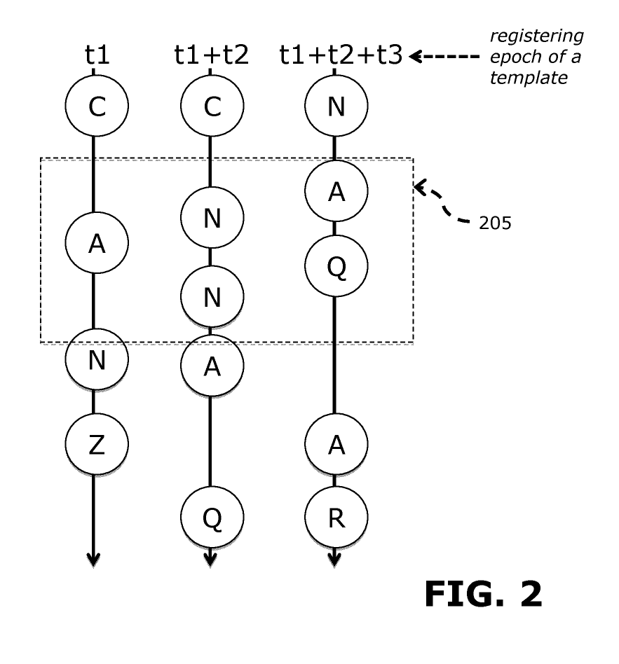

FIG. 2 provides a schematic representation of template registration and of computation of base configurations to preprovision a new template, in accordance with at least one embodiment of the invention. Individual templates are shown here with capital letters in circles. Shown are the registering epochs (or timepoints) of each of different new templates; thus, for instance, it can be seen that template “C” was registered at different timepoints. A sliding window of interest 205 is defined [Tₛ, Tₑ] and, for each trace i, the instances of requests Rᵢ which fall in this window are defined. For each Rᵢ, the time of occurrence Oᵢ relative to the registering epoch is determined, the pro-rata demand cᵢ, is determined in terms of the number of instance requests in Rᵢ, D, D^{w}ᵢ, and a requested “base” configuration set Yᵢ is determined. A weight xᵢ is computed with respect to the new template, in terms of template tags (as discussed in more detail herebelow). The weighted average of O and c over all traces i is computed, and the configuration set is taken as the multiset union over all traces i. Then, at time T, c instances of a given image are provisioned with a configuration chosen from Y.

In accordance with at least one embodiment of the invention, a closeness distance between two templates can be determined as follows. First, the tags associated with each of the two templates between which the closeness distance is to be determined are used to define a distance notion, wherein a tag is a combination of tag name and tag value. Associated with a tag name is its preference weight p, wherein this preference weight p is realized when the two templates are closest with respect to the tag name (i.e., it is a smaller number than p). (In other words, when two tag names are compared, two strings are being matched. The higher the similarity, higher the score will be, and the closer the match will be.) Each tag has rules which help in determining the closeness distance between any two tagged templates with respect to that tag name. For instance, in considering the tag name “version”, assume that the value space of “version” is integer-based, such that each subsequent version of the template assumes a version value which is 1 more than the previous version. Let p for “version” be defined as 10 (on a scale of 0 to 10, where 10 is the highest).

Continuing, in accordance with at least one embodiment of the invention, if the new template has version value 5 and the old template has version value 4, then its distance to with respect this tag name is the least and the distance assumes the value 10. If the old template had a version value smaller than 4, e.g., 3, then the distance would be 10 divided by 2, or 5, and so on. On the other hand, if the templates are not related (with to respect to the version tag), then the closeness distance is defined to be 0. Then, to compute the overall closeness distance, the distances are summed with respect to each of the tag names for both of the templates. This distance is normalized by the sum of the p-values for all tag names considered for the templates.

In accordance with at least one embodiment of the invention, tags for a template can take on a variety of different forms for characterizing a template. Tags may include, but by no means be limited to: “created by” (i.e., the person who registered the template); user vector (i.e., a list of users for the template); version; component vector; and hardware vector. A component vector can represent software contained in a template can be used as a way to characterize a template. For instance, if a template A contains (WAS, LINUX), B contains (DB2, Linux), and C contains (DB2, XP) then B is closer to C than it is to A. Any of a great variety of tools (such as the CIT [Common Inventory Technology] tool from Tivoli of International Business Machines Corporation [Armonk, N.Y.]) can be used to perform auto discovery of these software components from an offline image template, but manual tagging of templates can be undertaken as well. A hardware vector can represent a virtual hardware specification, if indeed part of a template.

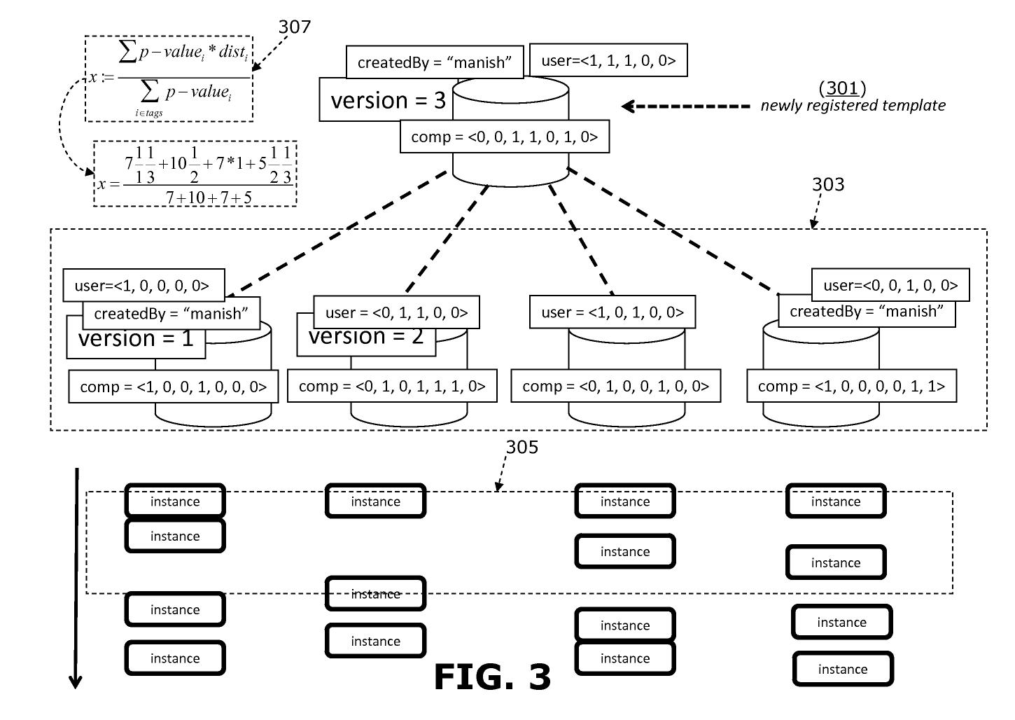

FIG. 3 schematically illustrates a distribution of demand and weights of old templates with respect to a newly registered template 301, in accordance with at least one embodiment of the invention. As shown, older templates 303 each may have limited information associated with them. A sample calculation of x is also shown (307). Also shown in FIG. 3 is a sliding window of interest 305 used to ascertain previous demand for the older templates, in a manner similar to that described and illustrated with respect to FIG. 2.

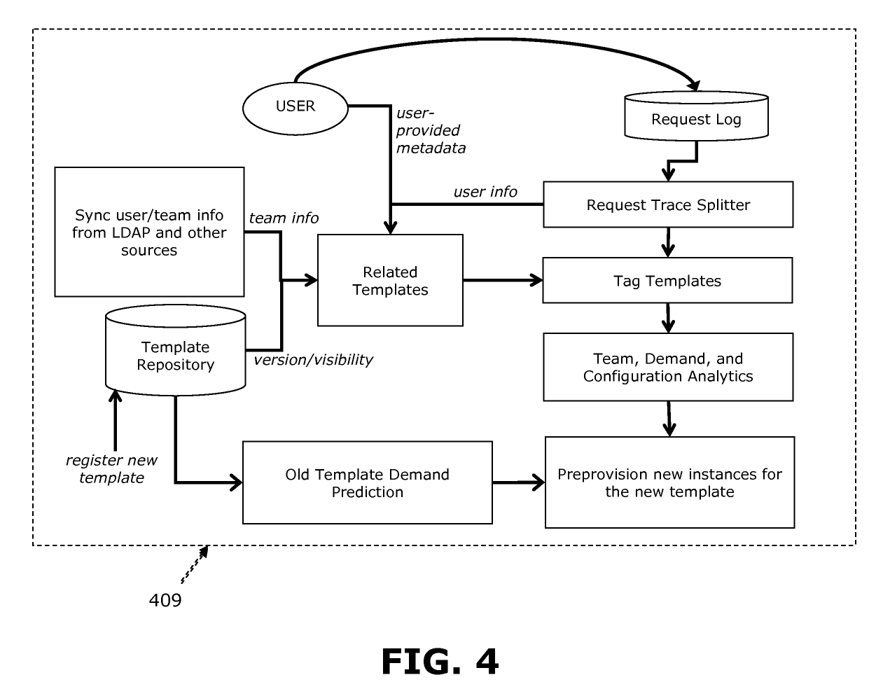

FIG. 4 schematically illustrates a general process 409 for estimating new template demand, in accordance with at least one embodiment of the invention. By way of illustrative example, the process may be performed in the context of arrangements discussed hereinabove with respect to FIGS. 1-3. As such, a new template (itself having been registered in a template repository) can be requested by a user via a request log, which prompts a request for a trace splitter with respect to related templates. User information can be carried from the request log along with user-provided metadata to be combined with other input such as team information (wherein user and team information can be synched from different sources, e.g., an LDAP registry and other sources), and template version and visibility to produce a set of related templates. These are then tagged, and analytics (with respect to team, demand and configuration) are performed. Combined with demand prediction with respect to old templates, new instances for the newly registered template are provisioned.

In accordance with at least one variant embodiment of the invention, recency of traces can also enter in as a factor (with respect to the process shown in FIG. 4). Particularly, older traces may be given lesser weight. Thus the weight computed for each trace may be further weighted by a factor that gives less weight to an older trace as compared to a more recent trace, and this can help account for a user ID shifting between different teams.

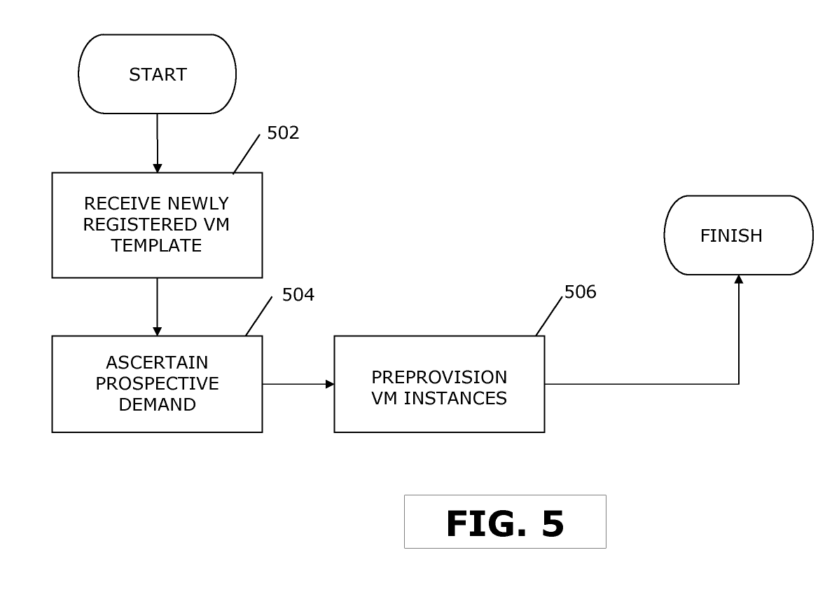

FIG. 5 sets forth a process more generally for estimating demand for a virtual machine template, in accordance with at least one embodiment of the invention. It should be appreciated that a process such as that broadly illustrated in FIG. 5 can be carried out on essentially any suitable computer system or set of computer systems, which may, by way of an illustrative and non-restrictive example, include a system such as that indicated at 12′ in FIG. 6. In accordance with an example embodiment, most if not all of the process steps discussed with respect to FIG. 5 can be performed by way of a processing unit or units and system memory such as those indicated, respectively, at 16′ and 28′ in FIG. 6.

As shown in FIG. 5 in accordance with at least one embodiment of the invention, a newly registered virtual machine template is received (502), and prospective demand for the template is ascertained (504). Virtual machine instances are preprovisioned from the template (506).

Referring now to FIG. 6, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
receiving a newly registered virtual machine template;
ascertaining prospective demand for the template; and
preprovisioning virtual machine instances from the template.

2. The method according to claim 1, wherein said ascertaining comprises ascertaining demand based on previously registered templates that are determined to be similar.

3. The method according to claim 2, wherein said ascertaining comprises computing closeness between the newly registered template and at least one previously registered template.

4. The method according go claim 3, wherein said computing comprises tagging the newly registered template and at least one previously registered template with identifying information for comparison.

5. The method according to claim 1, wherein said ascertaining comprises estimating demand on the basis of a weighted average of demand relative to previously registered templates.

6. The method according to claim 5, wherein said estimating comprises determining, over a predetermined time window, demand relative to previously registered templates.

7. The method according to claim 1, wherein said estimating comprises determining, over a predetermined time window, demand relative to previously registered templates.

8. The method according to claim 1, wherein said preprovisioning comprises identifying a number of virtual machine instances.

9. The method according to claim 1, wherein said preprovisioning comprises identifying a configuration of each virtual machine instance.

10. An apparatus comprising:
at least one processor; and
a computer readable storage medium having computer readable program code embodied therewith and executable by the at least one processor, the computer readable program code comprising:
computer readable program code configured to receive a newly registered virtual machine template;
computer readable program code configured to ascertain prospective demand for the template; and
computer readable program code configured to preprovision virtual machine instances from the template.

11. A computer program product comprising:
a computer readable storage medium having computer readable program code embodied therewith, the computer readable program code comprising:
computer readable program code configured to receive a newly registered virtual machine template;
computer readable program code configured to ascertain prospective demand for the template; and
computer readable program code configured to preprovision virtual machine instances from the template.

12. The computer program product according to claim 11, wherein said computer readable program code is configured to ascertain demand based on previously registered templates that are determined to be similar.

13. The computer program product according to claim 12, wherein said computer readable program code configured to compute closeness between the newly registered template and at least one previously registered template.

14. The computer program product according go claim 13, wherein said computer readable program code is configured to tag the newly registered template and at least one previously registered template with identifying information for comparison.

15. The computer program product according to claim 11, wherein said computer readable program code is configured to estimate demand on the basis of a weighted average of demand relative to previously registered templates.

16. The computer program product according to claim 15, wherein said computer readable program code is configured to determine, over a predetermined time window, demand relative to previously registered templates.

17. The method according to claim 11, wherein said computer readable program code is configured to determine, over a predetermined time window, demand relative to previously registered templates.

18. The method according to claim 11, wherein said computer readable program code is configured to identify a number of virtual machine instances.

19. The method according to claim 11, wherein said computer readable program code is configured to identify a configuration of each virtual machine instance.

20. A method comprising:
receiving a newly registered virtual machine template; and
ascertaining prospective demand for the template;
said ascertaining comprising:
identifying previously registered templates that are determined to be similar, via a quantitative closeness score computed between the newly registered template and the previously registered templates; and
estimating demand on the basis of a weighted average of demand relative to the previously registered templates.
